(19) United States
(12) Patent Application Publication
(10) Pub. No.: US 2005/0101290 A1
(43) Pub. Date: May 12, 2005

(54) Communications system

(76) Inventor: Jorge Melgosa, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/702,051

(22) Filed: Nov. 6, 2003

(51) Int. Cl. H04M 11/00

(52) U.S. Cl. 455/406; 455/405

(57) ABSTRACT

A communications system includes a first communications node, a second communications node, a plurality of charging nodes and, a memory. The first node includes a system for sending information to at least one of a charging nodes, and the second node includes a system for sending information to at least one of the charging nodes. The memory includes a unit for storing information identifying at least one of the charging nodes. The first and second node are configured to send respective information to the at least one charging node in dependence on the information stored in the memory.

### FIELD OF THE INVENTION

This invention relates to methods and apparatus for charging in a telecommunications system. The invention is especially, but not exclusively, suitable for implementation in the UMTS (Universal Mobile Telecommunications System)/GPRS (general packet radio system) architecture.

### BACKGROUND OF THE INVENTION

Wireless cellular communication networks are generally widely known. In such a system the total area covered by the communication network is divided into cells. Each cell is provided with a base transceiver station which is arranged to communicate with mobile stations or other user equipment in the cell associated with the base transceiver station.

In these known systems, a channel is allocated to one user. This channel can be considered to be a circuit switched channel, in other words the user is connected to the base station via this channel, and uses this channel while data is passes from user equipment to the base transceiver station. For example in the case of the GSM (Global System for Mobile Communications) standard, a user is allocated a given frequency band and a particular timeslot in that frequency band. In other communication systems such as the code division multiple access (CDMA) systems more than one user equipment element may be assigned to the same physical resource, but may be distinguished from each other by use of an added code sequence. Data passing through such systems, to an external server passes through a specified path from the user equipment, to the cell base transceiver station, to a base station controller, to a gateway, before travelling to the external server.

Computer networks external to the wireless communications system, such as the network of computers known as the Internet communicate using data in packet form. These packets are presented to the network, which then pass from network node to network node until they reach their destination. The actual path taken by the network packets is not considered to be important and sequential packets may not always take the same path from transmit node to receive node.

Several wireless communication protocols attempt or propose either true wireless packet communications or packet communication emulation within a switched network. One example is GPRS (General Packet Radio System) networks, which may be implemented either as part of a GSM network or as part of a CDMA system. An example of a CDMA system is the universal mobile telecommunications system (UMTS) which can incorporate parts of the GPRS and GSM network elements.

The UMTS system is also known as the 3^{rd} generation or 3G network system.

Billing within the UMTS/GPRS system is carried out from various functional elements transmitting charging data records (CDRs) to a billing system. The billing system then collates the CDRs for each subscriber. Whilst some network elements are capable of supplying the CDRs to the billing system directly some of the switching nodes within the network pass their CDRs to a network element carrying out a charging gateway function (CGF). The charging gateway function performs an initial collation and filtering on the received CDRs and passes the processed CDRs to the billing system. If the charging gateway function is carried out separate from any other function the charging gateway function is said to be carried out in a charging gateway (CG). A single network provided by a network provider may have several charging gateways.

Within each mobile telecommunications network there will be several types of switching nodes. Serving GPRS support nodes (SGSN) behave as a gateway between the users and the core network elements. The Gateway GPRS support nodes (GGSN) act as gateways between the core network elements and external networks the user wishes to connect to. These external networks can for example be a packet switched network such as the Internet or a separate core network belonging to another network provider.

Both the SGSN and GGSN pass CDRs to the charging gateways. In order that billing is accurate the CDRs from both the SGSN and GGSN for each subscriber and for each packet data protocol (PDP) should pass to a single charging gateway. In practice, a packet data protocol establishes the data protocol used in order that it may be possible to produce separate CDRs for each protocol used. An example of a packet data protocol is the Internet Protocol (IP).

The GGSN sends the CDRs for each subscriber/session/PDP context to a charging gateway. This charging gateway information is passed to the SGSN for each subscriber/session/PDP context in order that both the GGSN and SGSN send CDRs for each subscriber/session/PDP context to the same charging gateway. However in practice the GGSN always sends all the CDRs it generates to the charging gateway acting as the active charging gateway at any instant.

Thus if for any reason the active charging gateway changes in the GGSN, all of the CDRs created from that point are sent to the new active charging gateway. This can create the problem whereby for the same subscriber/session/PDP context CDRs generated by the GGSN are directed to the active charging gateway which is different to the charging gateway being addressed by the SGSN as originally instructed by the GGSN.

For instance one such occurrence may be when a user starts a GPRS session creating a first PDP context called PDP1 in a system with two charging gateways CG1 and CG2. The GGSN active charging gateway is initially CG1 and thus the SSGN is instructed to send CDRs for the context PDP1 to the first charging gateway CG1.

A problem can occur if for some reason the communication link from both the SGSN and GGSN to CG1 is lost. From this point both the SGSN and GGSN redirect the CDRs for the first packet data protocol context to the second charging gateway CG2. For the same reason the active charging gateway for the GGSN becomes CG2.

With the active charging gateway for the GGSN being CG2 any new packet data protocols created by the SGSN (for example a second GPRS session creating a PDP context PDP2) will be instructed to send the CDRs for the new packet protocol to the second charging gateway CG2. Similarly new session packet data protocols (for example PDP3) for the first session will also cause the GGSN to instruct the SGSN to send the CDRs to the active charging gateway CG2.

The problem now occurs as the SGSN remembers which charging gateway is to be used for each of the packet data protocols but the GGSN sends all of its CDRs to the active charging gateway. Thus when a connection is re-established with the first charging gateway CG1, the SGSN sends any new CDRs for the first packet data protocol to the first charging gateway CG1. However the active gateway for the GGSN is still the second charging gateway CG2 and any new CDRs for the first packet data protocol are sent to the second charging gateway CG2.

Thus for the first packet data protocol the CDRs from the GGSN and SGSN are not being received by the same charging gateway.

The prior art solution to this problem is to manually reset the GGSN active charging gateway to being the first charging gateway. This method though too has limitations. In the situation described above additional sessions or additional packet data protocol contexts have been created when the communications link failed. The active charging gateway is not the original charging gateway CG1. This simply resetting the GGSN active gateway in order to re-establish CDR synchronisation for one packet data protocol context may break the CDR synchronisation for a later packet data protocol.

### SUMMARY OF THE INVENTION

It is an aim of the embodiments of the present invention to address or at least partially mitigate one or more of the problems discussed previously.

There is provided according to the present invention a communications system comprising: a first communications node; a second communications node; a plurality of charging nodes; and a memory; said first node comprising means for sending information to at least one of said charging nodes, said second node comprises means for sending information to at least one of said charging nodes, said memory comprising means for storing information identifying at least one of said charging nodes; wherein said first node and said second node are arranged to send respective information to the same said at least one charging node in dependence on said information stored in said memory.

The first or second node may comprise means for selecting the said at least one charging node dependent on the context of communication data passing between said first node and said second node.

The context of communications data may be dependent on at least one of: a subscriber requesting or transmitting said communications data; a session requested by said subscriber; a packet data protocol used in said session requested by said subscriber.

The communications system may be a UMTS architecture communications system.

The communications system may be a GPRS architecture communications system.

The first communications node may be a gateway GPRS service node (GGSN).

The second communications node may be a serving GPRS support node (SGSN).

The at least one charging node may comprise a charging gateway function (CGF).

The at least one charging node may be a charging gateway (CG).

The memory may be located within said first or said second communications node.

A second memory may be located within the other of said first or second communications node, wherein said second memory may be arranged to store information identifying at least one of said charging nodes and said second memory may be arranged so that the value stored in said memory is synchronised with the value stored in said second memory.

The information sent by at least one of said first and second nodes may comprise at least one data record.

According to a second aspect of the present invention there is provided a method for billing in a communications system comprising the steps of: sending information from a first communications node to at least one of a plurality of charging nodes, sending information to a second communications node to at least one of a plurality of charging nodes, storing in a memory information identifying at least one of said plurality of charging nodes; wherein said first communications node and said second communications node are arranged to send respective information to the same at least one said charging node dependent on said information stored in said memory.

The method may further comprise the step of: selecting at least one charging node dependent on the context of communication data passing between said first communications node and said second communications node.

The method may further comprise the step of: passing a value identifying said selected at least one charging node to said memory device.

The step of selecting said at least one charging node may be dependent on at least one of: a subscriber requesting or transmitting said communications data; a session requested by said subscriber; a packet data protocol used in said session requested by said subscriber.

The method may further comprise the step of storing in a further memory device said information identifying at least one of said plurality of charging nodes.

The method may further comprise the step of maintaining said memory and said second memory so that the information identifying at least one of said charging nodes is the same.

According to a third aspect of the present invention there is provided a communication node for use in a communication system, said node being arranged to send information to a charging node, said node comprising a memory for storing information identifying the charging node to which said node is to send said information.

The node may be arranged to send said information in said memory to a second node.

### BRIEF DESCRIPTION OF THE DRAWINGS

Embodiments of the present invention will now be described by way of example with reference only to the accompanying drawings, in which:

FIG. 1 is a schematic diagram of a UMTS cellular telecommunications system;

FIG. 2 is a schematic diagram of the billing architecture for a UMTS telecommunications system using the example of a mobile station communicating to a packet data network in which embodiments of the present invention can be implemented;

FIG. 3 is a schematic diagram of a GGSN in a first embodiment of the present invention;

FIG. 4 is a flow diagram for a method of the first embodiment of the present invention;

FIG. 5 is a schematic diagram of a GGSN and SGSN in a second embodiment of the present invention;

FIG. 6 is a flow diagram for a method of the second embodiment of the present invention.

### DETAILED DESCRIPTION OF THE EMBODIMENTS OF THE PRESENT INVENTION

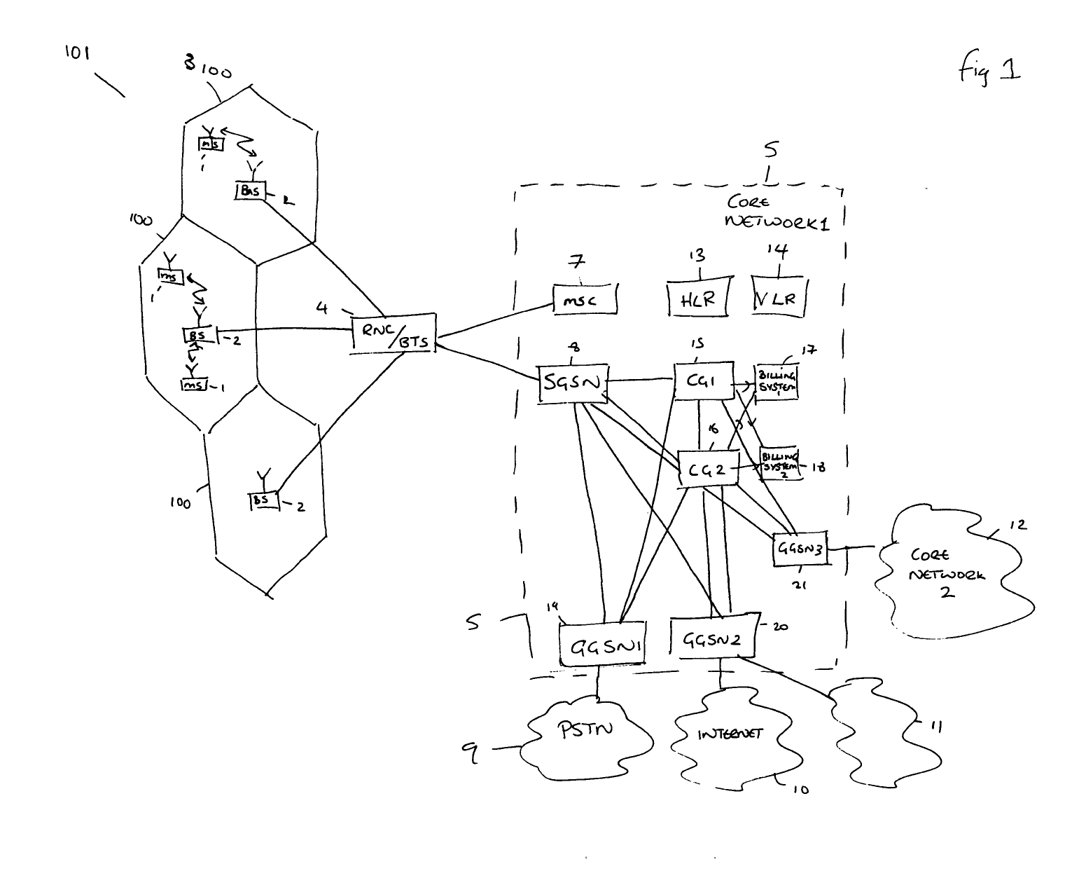

With reference to FIG. 1, the general logical architecture proposed for UMTS/GPRS communications system and also suitable for other systems in which embodiments of the present invention may be implemented is shown.

Various user equipment (UE) such as computers (fixed or portable), mobile telephones, personal data assistants or organisers and so on are known to the skilled person and can be used to access the Internet to obtain services. Mobile user equipment referred to as a mobile station (MS) 1 can be defined as a means that is capable of communication via a wireless interface with another device such as a base station of a mobile telecommunication network or any other station.

The term “service” used above and hereinafter will be understood to broadly cover any service or goods which a user may desire, require or be provided with. The term also will be understood to cover the provision of complimentary services. In particular, but not exclusively, the term “service” will be understood to include Internet protocol multimedia IM services, conferencing, telephony, gaming, rich call, presence, e-commerce and messaging e.g. instant messaging.

The mobile station (MS) 1 can communicate by radio with one or more base stations (BS) 2. Each base station is linked to a single radio network controller (RNC) 4. The terminology used for base station and RNC will depend on the standard. For example, base stations referred to as “Node B” and RNCs as “base station controllers”. It should be appreciated that the terms “base station” and “RNC” should be interpreted as also encompassing equivalent elements in other standards which perform a similar function.

It should also be appreciated that in some embodiments of the invention the RNC functionality can be distributed between the base stations.

Each base station 2, is further arranged such that it is capable of receiving and transmitting to mobile stations 1 within an predefined area 100. These areas interlock and can partially overlap to create a patchwork of mobile station coverage. Each base station is further arranged so that the physical resources used to communicate between mobile station and base station may be capable of reuse across the whole communications network 101.

Each RNC 4 can be linked to one or more BSs 2. Each RNC 4 is linked to a core network (CN) 5. The CN 5 includes one or more serving nodes that can provide communication services to a connected mobile station, for example a mobile switching centre (MSC) 7 and a serving GPRS (general packet radio service) support node (SGSN) 8. These units are connected to the RNCs 4. The CN 5 is also connected to other telecommunications networks such as a fixed line network 9, other mobile networks (e.g. another core network 12) or packet data networks 10, 11 such as the Internet or proprietary networks to allow onward connection of communications outside the UMTS network. The CN 5 also includes other units such as a home location register (HLR) 13 and a visitor location register (VLR) 14 which help to control access to the network. The HLR 13 stores the subscription details of mobile station subscribers to that CN 5 itself. The VLR 14 stores information on mobile stations that are currently attached to the CN 5 but which are not subscribed to that network. The BSs 2 and the RNCs 4 constitute a UMTS terrestrial radio access network (UTRAN).

Each core network 5 includes one or more charging gateway functionality entities 15, 16 and a billing system 17, 18 for performing billing operations. (In GPRS, for example, if the charging gateway functionality is embodied in a separate physical unit then the corresponding network element is known as a charging gateway (CG)). Each network entity generating charging information (such as GGSN and SGSN in GPRS) is linked at least to one charging gateway functionality (CGF), but for redundancy reasons typically to several CGFs. The charging gateways may also be linked together. When a mobile station is operating in another core network from the one to which it is subscribed (its home network), that other core network can communicate charging information to the home network by means of the charging gateways and billing systems so that the home network can bill the subscriber for his use of the other core network.

In the core network each serving node such as an MSC or SGSN can provide a set of services to the mobile station. For example:

An MSC can provide circuit switched (CS) communications, for example for speech, fax or non-transparent data services, and therefore has a link to other entities in the circuit switched domain such as other CS mobile networks such as GSM (Global System for Mobile communications) and CS fixed wire networks such as conventional voice telephony networks.

An SGSN can provide packet switched (PS) communications, for example for packet data protocol (PDP) contexts for Internet Protocol (IP) data transmission, and therefore has a link to other entities in the packet switched domain such as GPRS-equipped GSM networks and the Internet. The packet switched services may include traditional data services such as file transfer, e-mail and world-wide web (WWW) browsing and derived data services such as voice-over-IP (e.g. by means of the H.323 protocol).

The division of services between serving nodes is specified in the system specification and is tied to the assumed network architecture. There may be other nodes than the MSC or SGSN providing overlapping or additional services.

When a mobile station 1 begins operating for communication in the coverage area of the core network 5 it first undergoes a process of attachment to the core network 5. In that process the mobile station 1 indicates its identity, and then undergoes a process of attachment to the network. The core network 5 obtains subscription information for the mobile station from the HLR 13 of the core network 5 to which the mobile station 1 is subscribed. The subscription information includes access information indicating the services that the mobile station 1 is entitled to receive (e.g. the access points—for example in a GGSN 21—to which the mobile station may have access), and billing information indicating the method by which the subscriber is billed (e.g. normal subscription, pre-paid subscription, hot billing subscription or flat rate subscription; and whether billing is to be dependant on the access point that is used). Using that information the core network 5 can provide services to the mobile station 1 and cause the subscriber to be billed accordingly. After having attached to the network the mobile station may communicate to the core network 5 its need for communication services, for example involving activation of a PDP context in the GPRS system.

In some systems, e.g. GPRS, CDR (charging data record) tickets or other charging messages are collected by the charging gateway functionality and sent onwards as a file towards the appropriate billing system. These CDR tickets can be sent directly providing the billing system is operational or stored temporarily and passed periodically after some delay to the billing system. For example, such files may be sent every 10 or 30 minutes. In hot billing the messages are typically sent promptly towards the appropriate billing system or billing server after no delay or only a few seconds' delay. This can enable services such as advice of charge (AoC) and pre-paid subscriptions to be provided more effectively.

The core network includes gateway equipment 19, 20, 21 for interfacing with the other networks 9, 10, 11. Where the respective other network is a packet switched network (e.g. networks 10, 11) the gateway equipment is a GGSN (gateway GPRS support node), which interfaces between the SGSN 8 and the respective network. During a communication session and/or after a session has been completed the GGSN through which the session was routed generates one or more CDR ticket messages which are directed to the appropriate charging system so that the subscriber can be billed for the session.

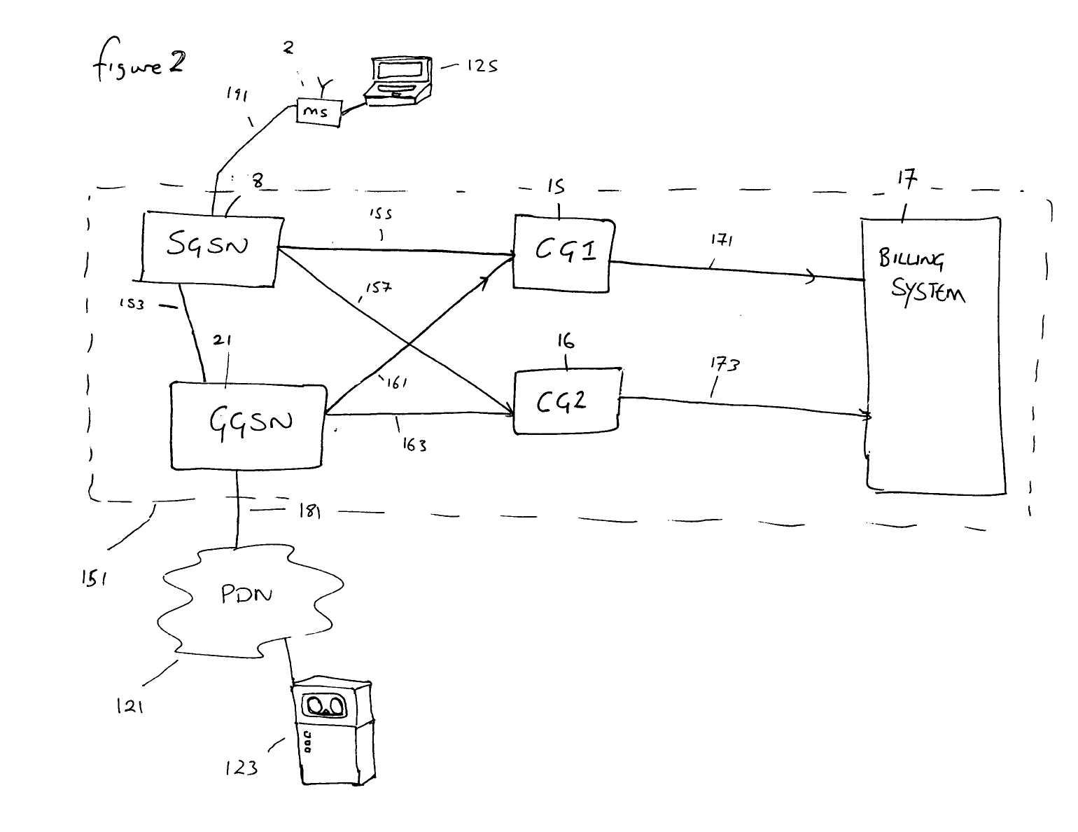

With reference to FIG. 2 the charging system as employed by an UMTS architecture and with reference to the SGSN 8 and GGSN 21 is described in further detail. The system as described is one in which embodiments of the present invention can be employed. In order to show the architecture in practice the architecture 151 is shown as part of a connection from a piece of user equipment wishing to access a file on a computer via a packet data network PDN 121.

Further although it is known that other entities within the UMTS system are capable of generating charging data records, for example the home location register 13, the examples will explicitly discuss the synchronisation between the SGSN 8 and GGSN 21.

The system as shown in FIG. 2 comprises a billing architecture 151, a mobile station 2, user equipment 125, a packet data network 121 and a target computer 123.

The billing architecture 151 with respect to a SGSN 8 and GGSN 21 comprises a serving GPRS service node (SGSN) 8, a gateway GPRS service node (GGSN) 21, a first charging gateway (CG1) 15, a second charging gateway (CG2) 16, a billing system 17 and a series of interconnects 153, 155, 157, 161, 163, 171, 173. The SGSN 8 and the GGSN are connected by the interconnect 153. The SGSN 8 and the first charging gateway 15 are connected by the interconnect 155. The SGSN 8 and the second charging gateway 16 are connected by the interconnect 157. The GGSN 21 and the first charging gateway are connected by the interconnect 161. The GGSN 21 and the second charging gateway are connected by the interconnect 163. The first charging gateway 15 is connected to the billing system 17 by the interconnect 171. The second charging gateway 16 is connected to the billing system 17 by the interconnect 173.

It is known in the art that the interconnects 153, 155, 157, 161, 163, 171, 173 used within the core network in some embodiments of the present invention may not be a designated circuit switched interconnect but may be a part of a packet switched network of interconnects whereby packets are sent from one entity to another along more than one route to reach the addressed entity. It is further known that there may be in other embodiments of the present invention more than two of such charging gateways. Alternately or additionally the functionality of the charging gateways may be implemented along with other functionality of the core network within a single unit.

The user equipment 125 is connected to the mobile station 2. Alternatively, the mobile station itself is the user equipment itself. This connection may be wireless using an infra-red or other short range electromagnetic wave connection or may be wired. The mobile station is connected to the billing architecture in a manner as described previously. This connection is shown in FIG. 2 as a link 191 between the mobile station 2 and the core network billing architecture 151. The core network billing architecture is connected to the target computer 123 via the packet data network 121. The packet data network is connected to the core network billing architecture 151 via the link 181.

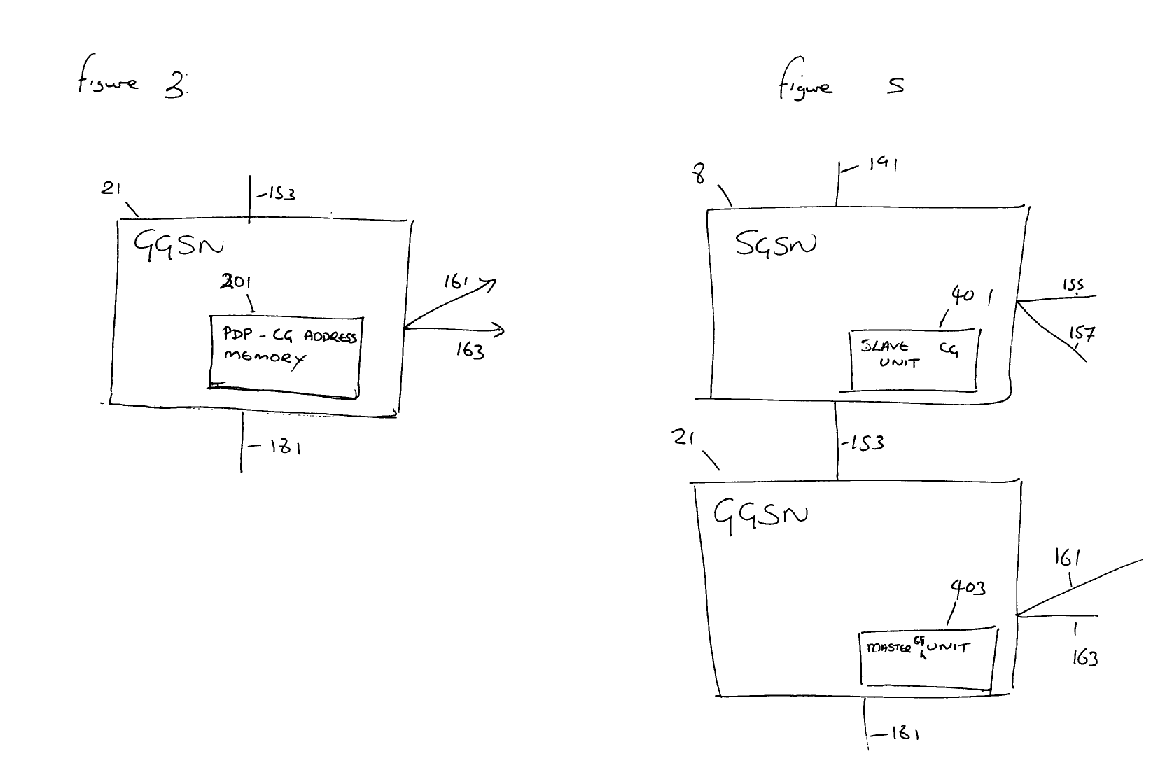

With reference to FIG. 3 the GGSN 21 as used in a first embodiment of the present invention is further described. The GGSN 21 comprises the features as known in art that enable the GGSN to carry out the functionality of a UMTS GGSN. The GGSN of the first embodiment of the present invention further comprises a packet data protocol—charging gateway memory unit 201.

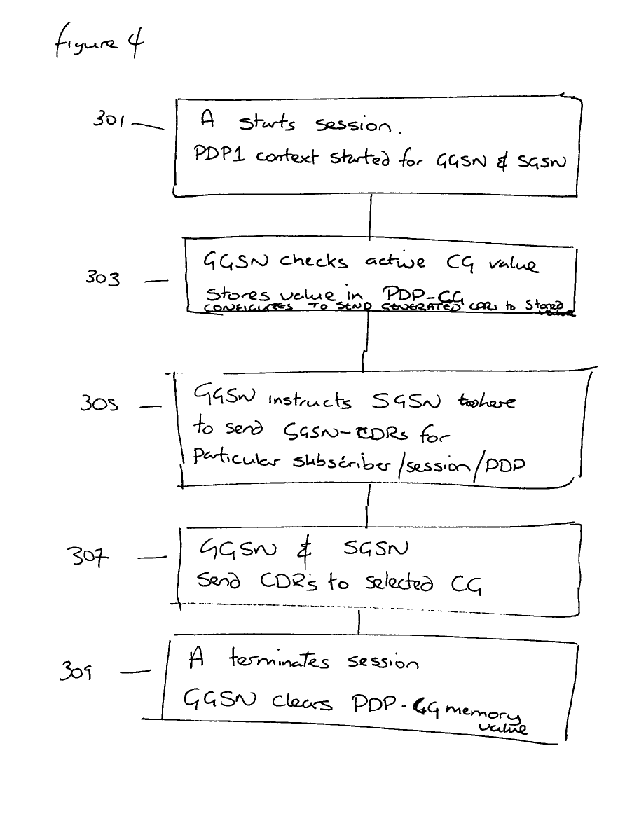

The use of the PDP-CG memory unit in directing the charge data records generated by the GGSN for a specific PDP is described with respect to FIG. 4 using the elements described in FIGS. 2 and 3.

The first step 301 is when a subscriber A using the user equipment 125 via the mobile station 2 starts a GPRS session. This activates a first PDP context (PDP1) for both the SGSN 8 and GGSN 21.

In the second step 303 the GGSN 21 checks to determine which charging gateway is currently assigned the active status. The GGSN 21 then stores the value in the PDP-CG memory unit 201 along with the value of the PDP context being set-up and configures itself to send any generated CDRs for this particular subscriber/session/PDP combination to the charging gateway stored in the PDP-CG memory unit 201.

By the third step 305, the GGSN instructs the SGSN 8 to which charging gateway to send the CDRs generated by the SGSN 8 for that particular subscriber/session/PDP combination. The SGSN 8 then prepares to send any generated CDRs for that combination to the ordered charging gateway.

In the fourth step 307 the GGSN 21 and SGSN 8 pass generated CDRs for this combination of subscriber/session/PDP to the same charging gateway.

In a final step 309 the session is terminated by the subscriber and the GGSN 21 and SGSN 8 no longer create or send further CDRs. Furthermore the GGSN deletes the memory value stored in the PDP-CG memory 201 during the second step.

As the GGSN 21 now stores the value of the charging gateway with respect to the PDP context the problem that occurred in the prior art is in embodiments of the present invention at least partially mitigated.

In this embodiment a failed connection causes both the SGSN 8 and GGSN 21 to switch the addressed charging gateway for passing CDRs to a charging gateway other than the original addressed charging gateway. The value stored within the PDP-CG memory 201 however remains the same.

The GGSN and SGSN as known in the art perform regular checks on the status of any of the noted failed charging gateways. These checks are therefore able to determine when a restoration of the connection to the original charging gateway has been achieved. Following the restoration of the connection to the original charging gateway the SGSN 8 operates as described by the prior art by sending new CDRs for the specific subscriber/session/PDP context to the charging gateway originally instructed by the GGSN 21 during the set-up of the PDP context.

The GGSN 21 in this embodiment of the present invention, rather than sending generated CDRs to the active charging gateway, uses the PDP-CG memory value 201 stored against the subscriber/session/PDP value and sends any CDRs for the specific subscriber/session/PDP context according to this value. Thus when the connection to the original charging gateway is restored the GGSN 21 sends new generated CDRs attributed to this subscriber/session/PDP combination to the original gateway as stored in the PDP-CG memory unit 201.

In other words for a particular subscriber/session/PDP combination the address to which the GGSN sends CDRs can be considered to have been reset to its original position following restoration from a communications link failure.

In this situation the problem of new sessions or new PDP contexts generated by a subscriber during the communications link failure to the primary CG is also dealt with in embodiments of the present invention. In such situations the new subscriber/session/PDP combination is set up in the same manner as dealt with in steps 301 to 307. New values are stored in the PDP-CG memory unit 201 and the SGSN 8 and GGSN 21 are arranged to pass the generated CDRs with respect to this subscriber/session/PDP combination to the new active charging gateway.

Following the restoration of the communications link even if the active charging gateway, i.e. the charging gateway for new PDP contexts, is reset to be the original charging gateway the CDRs generated by the SGSN 8 and GGSN 21 are still sent to the same charging gateway as defined during the setting up of the subscriber/session/PDP combination. The GGSN 21 sending the CDRs created by that subscriber/session/PDP combination as defined by the value stored in the PDP-CG memory unit 201 for that subscriber/session/PDP combination and the SGSN 8 sending the CDRs for the same subscriber/session/PDP combination to the charging unit as instructed by the GGSN 21 during the set up of the subscriber/session/PDP combination.

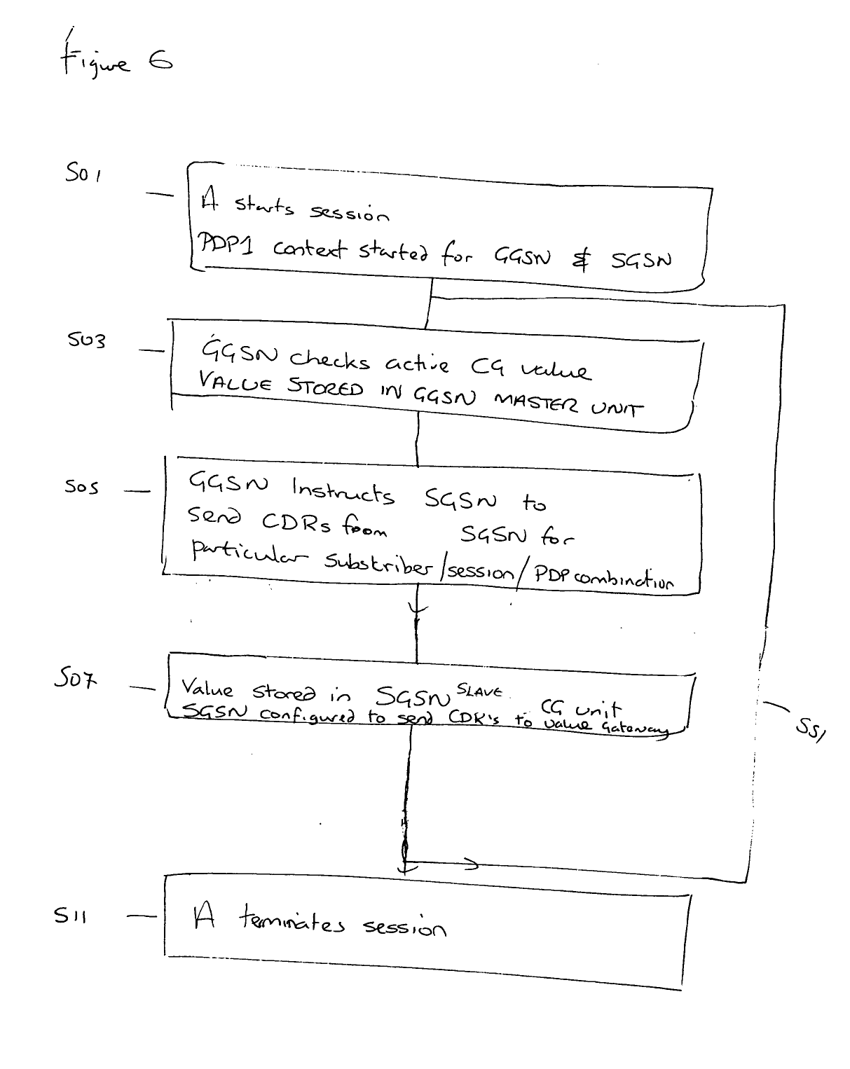

A second embodiment of the present invention is shown in FIG. 5. FIG. 5 shows a SGSN 8 and GGSN 21 connected as previously shown in FIG. 2 by the interconnect 153. The SGSN 8 is further connected as previously shown in FIG. 2 to the mobile station (not shown) by the interconnect 191. The SGSN 8 is further connected as previously shown to the first charging gateway (not shown) by interconnect 155, and the SGSN is further connected to the second charging gateway (not shown) by interconnect 157. The GGSN is connected as previously shown in FIG. 2 to the packet data network (not shown) via the interconnect 181. The GGSN 21 is further connected to the first charging gateway (not shown) by interconnect 161 and to the second charging gateway (not shown) by interconnect 163.

In FIG. 5 the SGSN as described in previous embodiments and the prior art further comprises a slave CG direction unit 401. The slave CG direction unit 401 is a memory unit capable of storing values which can be used to configure the SGSN to send CDRs for a particular subscriber/session/PDP combination to a defined charging gateway.

The GGSN as described in the prior art further comprises a master CG direction unit 403. The master CG direction unit 403 is a memory unit capable of storing values which can be used to configure the GGSN to send CDRs for a particular subscriber/session/PDP combination to a defined charging gateway.

The slave CG direction unit 401 is further arranged to receive the value from the master CG direction unit 403.

The second embodiment's use of the master/slave CG units in directing the charge data records generated by the GGSN and SGSN for a specific subscriber/session/PDP combination is described with respect to FIG. 6 using the elements described from FIGS. 2 and 5.

The first step 501 is when a subscriber A using the user equipment 125 via the mobile station 2 starts a GPRS session. This activates a first PDP context (PDP1) for both the SGSN 8 and GGSN 21.

In the second step 503 the GGSN 21 checks to determine which charging gateway is currently assigned the active status. The active value with respect to this subscriber/session/PDP combination is then stored in the GGSN master CG unit 403. The GGSN 21 then is configured to send any generated CDRs for that subscriber/session/PDP combination to the charging gateway addressed by the stored value

The third step 505 occurs when the GGSN instructs the SGSN 8 to which charging gateway to send the CDRs generated by the SGSN 8 for that particular subscriber/session/PDP combination. GGSN master CG unit. The GGSN 21 then is configured to send any generated CDRs for that subscriber/session/PDP combination to the charging gateway addressed by the stored value.

In the fourth step 507 the active CG value received by the SGSN 8 is stored in the SGSN slave CG unit 401 with the subscriber/session/PDP combination value. Using the received value the SGSN 8 then is configured to send any generated CDRs for that subscriber/session/PDP combination to the charging gateway addressed by the received value.

Finally in the fifth step 511 the subscriber A terminates the session and the values written into the master 401 and slave 403 units are deleted.

Thus while a session is created the master and slave units are synchronised and the SGSN 8 and GGSN 21 are configured to send the CDRs for a specific subscriber/session/PDP combination to the same charging gateway.

The problem with a communications fault to the charging gateway addressed by both the SGSN 8 and GGSN 21 can be handled in a way similar to the previous embodiment. During the fault the SGSN 8 and GGSN 21 send the created CDRs with reference to a specific subscriber/session/PDP combination to an alternative charging gateway dependent on the routing information stored within the GGSN and SGSN in the eventuality of a communications fault to one or more of the charging gateways. In one embodiment of the present invention the values stored within the master CG direction unit 401 and the slave CG direction unit 403 are not changed to reflect the change in addressing of the CDRs during the communications failure. Then following the recovery from the communications failure the SGSN 8 and GGSN 21 revert to sending CDRs to the charging gateway stored within the master and slave CG direction units, in other words the charging gateways allocated during the original configuration steps.

In a further embodiment of the present invention the configuration synchronisation can be carried out using a loop 551. This loop 551 is carried out while waiting for the termination of the session. In this loop the billing process as shown in FIG. 6 passes itself back to the step whereby the GGSN examines the address value for a specific subscriber/session/PDP combination stored in the GGSN 21 and passes this address value to the SGSN 21. Thus if for any reason the GGSN 21 is forced to re-address the CDR location for a specific subscriber/session/PDP combination, for example during a temporary or permanent failure of the communications link between the CDR generating function and the charging gateway, the SGSN 8 is reconfigured to follow the same routing used for the GGSN CDR generating function and thus to send CDRs to the same charging gateway.

This further embodiment of the present invention the loop message from the GGSN to the SGSN can be used to inform the SGSN changes or additions to billing information detected by the GGSN. For example these changes may be to a list of charging gateways available for use after the GGSN detects that a charging gateway can not be reached. This embodiment differs from prior art method which only updates the SGSN in response to the SGSN requesting an update PDP context because of a quality of service problem or a change in the SGSN.

The embodiments as described above can be used as the basis of further embodiments. In a further embodiment of the present invention the charging gateway selected to be used by a specific session or subscriber is not simply chosen as being the active gateway but is chosen in order to force all of the same session or subscriber packet data protocol context CDRs to be processed by the same charging gateway. This creates a session default charging gateway which is only not used where a communications failure causes the CDRs to be temporarily received by an alternative charging gateway.

Thus in such an embodiment as a user generates more PDP contexts for the existing session, all of the CDRs generated by the GGSN and SGSN are addressed to the same charging gateway as the original address for the first PDP context (providing it is possible). There is further no requirement to store further charging gateway addresses than those already determining which charging gateway address to send the original session PDP contexts when requesting further session PDP contexts.

In a further embodiment of the present invention the PDP-CG address unit 201, slave CG unit 401 and master CG unit 403 stores for each user/session/PDP context the address of a charging gateway to be used in event of the original charging gateway fails.

In a further embodiment of the present invention the SGSN and GGSN communication nodes are configured to automatically route the CDRs to an alternative charging gateway where a first addressed charging gateway fails.

In such an embodiment the operator configures the GGSN and SGSN by providing a list of addresses for charging gateways the GGSN and SGSN can pass CDRs to. Furthermore the list provides an original order of the priority of which charging gateway is to be used. The GGSN and SGSN then use the list to address the CDRs to the charging gateway available using a round robin system. Thus if the charging gateway at the top of the list fails the next charging gateway is used. If that too fails then the following gateway on the list is used. When the bottom of the list is reached the pointer to the next available charging gateway resets to the initial charging gateway at the top of the list.

In a further embodiment the PDP-CG address unit is located outside of the charging gateway. Similarly the functionality of the slave CG unit 401 and master CG unit 403 is merged and located outside of the GGSN and SGSN. In such an embodiment both the GGSN and SGSN fetch from the external element the address of the CG unit to be addressed for a specific subscriber/session/PDP combination.

The embodiments described above have been discussed in context of a GPRS or UMTS communications system. The present invention as shown in the embodiments can also be applied to other communications systems implementing similar billing systems.

Furthermore the present invention has described the present invention in the context of the general gateway service node and the switching gateway service node but could be applied to elements within communications systems incorporating the same or similar functionality.

1. A communications system comprising:
a first communications node;
a second communications node;
a plurality of charging nodes; and
a memory;
said first node comprising means for sending information to at least one of said charging nodes,
said second node comprises means for sending information to at least one of said charging nodes,
said memory comprising means for storing information identifying at least one of said charging nodes; wherein
said first node and said second node are arranged to send respective information to the same said at least one charging node in dependence on said information stored in said memory.

2. A communications system as claimed in claim 1, wherein said first or second node comprise means for selecting the said at least one charging node dependent on the context of communication data passing between said first node and said second node.

3. A communications system as claimed in claim 2, wherein the context of communications data is dependent on at least one of:
a subscriber requesting or transmitting said communications data;
a session requested by said subscriber;
a packet data protocol used in said session requested by said subscriber.

4. A communications system as claimed in claim 1, wherein said communications system is a UMTS architecture communications system.

5. A communications system as claimed in claim 1, wherein said communications system is a GPRS architecture communications system.

6. A communications system as claimed in claim 1, wherein said first communications node is a gateway GPRS service node (GGSN).

7. A communications system as claimed in claim 1, wherein said second communications node is a serving GPRS support node (SGSN).

8. A communications system as claimed in claim 1, wherein said at least one charging node comprises a charging gateway function (CGF).

9. A communications system as claimed in claim 1, wherein said at least one charging node is a charging gateway (CG).

10. A communications system as claimed in claim 1, wherein said memory is located within said first or said second communications node.

11. A communications system as claimed in claim 10, further comprising a second memory located within the other of said first or second communications node, wherein said second memory is arranged to store information identifying at least one of said charging nodes and said second memory is arranged so that the value stored in said memory is synchronised with the value stored in said second memory.

12. A communications system as claimed in claim 11, wherein said information sent by at least one of said first and second nodes comprises at least one data record.

13. A method for billing in a communications system comprising the steps of:
sending information from a first communications node to at least one of a plurality of charging nodes,
sending information to a second communications node to at least one of a plurality of charging nodes,
storing in a memory information identifying at least one of said plurality of charging nodes; wherein
said first communications node and said second communications node are arranged to send respective information to the same at least one said charging node dependent on said information stored in said memory.

14. A method as claimed in claim 13, further comprising the step of:
selecting at least one charging node dependent on the context of communication data passing between said first communications node and said second communications node.

15. A method as claimed in claim 14, further comprising the step of:
passing a value identifying said selected at least one charging node to said memory device.

16. A method as claimed in claim 14, wherein the step of selecting said at least one charging node is dependent on at least one of:
a subscriber requesting or transmitting said communications data;
a session requested by said subscriber;
a packet data protocol used in said session requested by said subscriber.

17. A method as claimed in claim 13, further comprising the step of storing in a further memory device said information identifying at least one of said plurality of charging nodes.

18. A method as claimed in claim 17, further comprising the step of maintaining said memory and said second memory so that the information identifying at least one of said charging nodes is the same.

19. A communication node for use in a communication system, said node being arranged to send information to a charging node, said node comprising a memory for storing information identifying the charging node to which said node is to send said information.

20. A node as claimed in claim 20, wherein said node is arranged to send said information in said memory to a second node.
